(19) United States
(12) Patent Application Publication
(10) Pub. No.: US 2013/0097306 A1
(43) Pub. Date: Apr. 18, 2013

(54) SYSTEM AND METHOD FOR MONITORING, MANAGING AND CONTROLLING A PLURALITY OF DEVICES USING CLOUD RESOURCES

(71) Applicant: Nav Dhunay, Calgary (CA)

(72) Inventor: Nav Dhunay, Calgary (CA)

(21) Appl. No.: 13/275,879

(22) Filed: Oct. 18, 2011

(51) Int. Cl. G06F 15/173

(52) U.S. Cl. 709/224

(57) ABSTRACT

A system is provided for providing monitoring, control, and/or management network infrastructure that comprises a controller that is configured to interface with an external cloud based computing environment, and to link to the cloud to obtain configuration information for (i) connecting to one or more devices, and (ii) to interoperate with the cloud for monitoring, controlling, or managing the one or more devices. The system interoperates with the cloud to: (i) offload data manipulation and management to the cloud; (ii) provide remote access to or control of the main controller component; and/or (iii) utilize the cloud as an automated service for access to remote storage and processing in association to enhance the operation of a plurality of devices at the location. A related method and related computer programming are also disclosed.

### FIELD OF THE INVENTION

This invention relates generally to monitoring and controlling a plurality of network-connected devices. This invention relates more specifically to cloud computing technologies.

### BACKGROUND OF THE INVENTION

Consumers and businesses alike are experiencing the increase in the number of network-connected devices that exist or are installed in any given environment, such as a house, apartment, or business premise. The devices may include computers, smart phones, entertainment systems, appliances, resource management monitoring devices, energy management systems, security systems, and so on. More and more devices are becoming Internet network-connected to enable for example remote monitoring or linking to remote data or resources. While these numerous network-connected devices provide a wide array of resources and offering to consumers and businesses, managing this significant number of network-connected devices, including in some cases the associated control devices such as remote controls, each often having its own interface or control workflow, and also managing the various information objects that may be stored to these devices or made available through these devices, has become increasingly difficult.

Furthermore, there is often a desire to control these devices from outside of a location, using for example a smart phone, but configuring these various devices for remote control can be difficult (especially with multiple device or control languages or protocols), complicated or at least time consuming.

In addition, these devices can generate or be associated with a wide variety of information objects such as content files (e.g. music files, video files, text files), documents, telemetric data etc., and storing and managing access to such informtion objects to provide meaningful access thereto on an as needed basis can also be difficult (again especially with the multiple device or control languages or protocols), complicated or at least time consuming.

Especially given the fact that the number and sometimes complexity of these devices continues to increase, there is a need for an improved system and method for enables one or more users, whether for personal use or for business use, to easily and efficiently monitor and control, and otherwise manage, a varying set of network-connected devices.

Also, language provides a significant barrier. Numerous devices and associated control devices do not support different languages and providing a mechanism that enables access to control function translations to a variety of languages is desirable, especially with the adoption of various devices in countries that do not speak English for example which is the only language supported by many devices and associated control devices.

There is also a need for central control of the various devices in a way that enables easy customization of control workflow and associated control commands based on what the user finds intuitive.

Also, many users are interested in storage and back-up services but these can be difficult to implement, especially in connection with multiple devices.

There is therefore a need for a control/management system and solution that addresses the aforesaid and other needs.

### SUMMARY OF THE INVENTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

In one aspect of the invention, a system for providing monitoring, control, and/or management network infrastructure comprising: a controller that is configured to interface with an external cloud based computing environment, and to link to the cloud to obtain configuration information for (i) connecting to one or more devices, and (ii) to interoperate with the cloud for monitoring, controlling, or managing the one or more devices.

In a further aspect of the system, the controller interoperates with the loud to: (i) offload data manipulation and management to the cloud; (ii) provide remote access to or control of the main controller component; and/or (iii) utilize the cloud as an automated service for access to remote storage and processing in association to enhance the operation of a plurality of devices at the location.

In a still further aspect of the invention, a computer-implemented method for enabling the monitoring, control and/or management of one or more devices: installing a controller at a location associated with the one or more devices; specifying a configuration application by operation of a managed cloud services; the controller obtaining information regarding the one or more devices and based on this information the controller obtaining configuration information for the controller connecting to the one or more devices, and for enabling the controller to monitor, control and/or manage the one or more devices; and the controller enabling one or more users to monitor, control and/or manage the one or more devices, including using one or more control devices linked to the controller.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

FIG. 1 depicts an exemplary system diagram illustrating the architecture of the present invention.

FIG. 2 is a system diagram that illustrates the network architecture of the present invention, in a particular embodiment thereof.

FIG. 3 illustrates services available in the cloud.

FIG. 4 illustrates a start-up routine of a controller.

FIG. 5 illustrates a client device utilizing local control when the controller is available, or directly to the cloud where the controller is not available.

FIG. 6 illustrates a controller linked to a plurality of control devices by a wireless network.

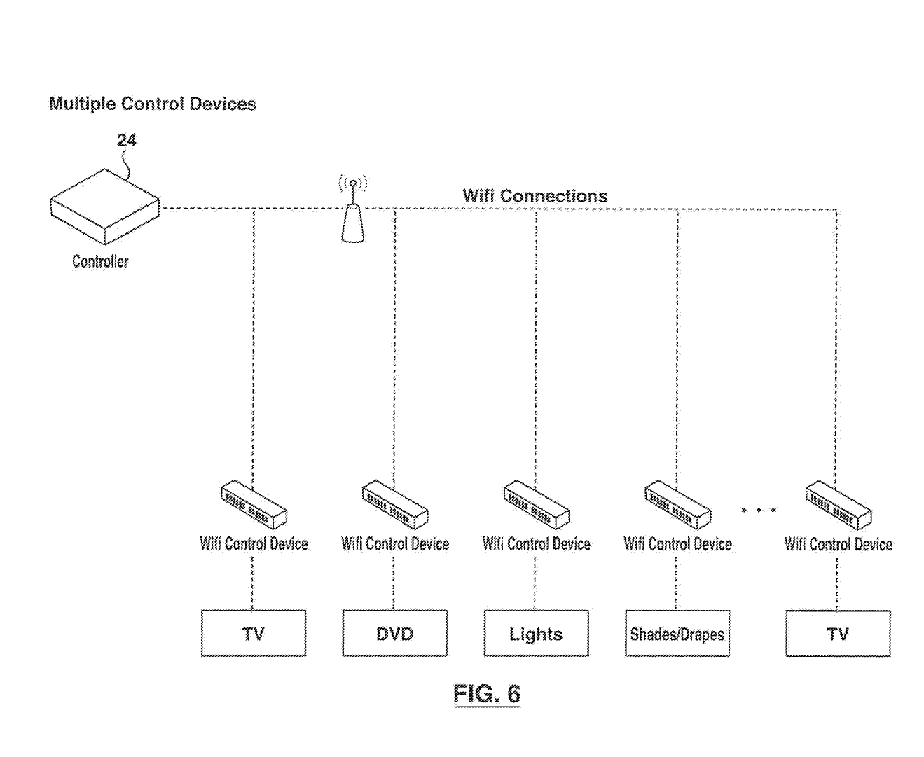

FIG. 7 illustrates notification sent to a client.

FIG. 8 illustrates user control of a control device.

FIG. 9 illustrates an embodiment of a controller.

FIG. 10 illustrates operation of the present invention based on monitoring of a control device.

### DETAILED DESCRIPTION OF PREFERRED EMBODIMENTS

The following terms are used throughout the description, the definitions of which are provided herein to assist in understanding various aspects of the subject innovation. It is to be understood that the definitions are not intended to limit the scope of the disclosure and claims appended hereto in any way.

In one aspect of the invention, the system of the present invention provides an automation and control architecture for a “location” that includes a main controller component that is configured to interface with an external cloud based computing environment to: (i) offload data manipulation and management to the cloud; (ii) provide remote access to or control of the main controller component; and/or (iii) utilize the cloud as an automated service for access to remote storage and processing in association to enhance the operation of a plurality of devices at the location.

The “location” is best understood as any physical or virtual environment associated with an “entity”, where the “entity” manages one or more devices or services associated with the “location”. The “entity” may be one or more individuals that reside in or use the location. The “entity” may be a family or a business for example. The “location” may be a home, but it also may be a business premise, or virtual environment associated with multiple devices or services.

The multiple devices may be a plurality of systems or devices located in a home, each having its own control device that may be a wired or a wireless device. In one aspect of the invention, a tool and service is provided for linking the control devices to the main controller component for central management and control. By operation of the present invention, the main controller component acts as a router or gateway to a plurality of wired or wireless control devices associated with the location.

In a particular aspect of the invention, explained in greater detail below, the present invention provides a home automation and control architecture with the attributes mentioned above.

In another aspect of the present invention, the control system of the present invention is provided so that configuration and customization programming, including control logic programming, is made available in the cloud, and is transmitted along with configuration data to the main controller component on an on demand basis.

The present invention provides a number of advantages including:
1. A novel control architecture is provided that integrates cloud computing in the control and management of the location, for example a home.
2. The control architecture and associated system and solution also enable the integration of a plurality of devices, and their associated control devices, despite the fact that the devices and/or their control devices may utilize a wide variety of languages or protocols.
3. The control architecture provides a useful way to enable the control of a plurality of devices, where one or more devices may have disparate control devices, thereby enabling a single control device or “universal controller” or “universal remote control”, provided by or linked to the main controller component, to enable control of the plurality of devices.
4. The single control devices may be used to control a variety of network-connected devices for example lighting systems, alarm systems, irrigation systems, heating systems, cooling systems, power management systems, entertainment systems, appliances, and so on.
5. The control architecture provides access to a wide variety of and rich configuration and customization programming, provided centrally with economies of scale, which may be dynamically added to the functions of the main controller component and thereby implemented easily for enhanced control or management of the plurality of devices. This aspect for example enables better and easier implementation of resource management techniques for enabling reduction in resource consumption and carbon footprint.
6. The control architecture enables the main controller component to incorporate the control language or protocol of a wide variety of devices. Access to such control language or protocol can be organized centrally, leveraging critical mass, in order to remain up to date as it relates to an expanding arrange of devices and associated control languages or protocols.

In another aspect of the invention, the configuration and customization programming may include control function translations to a variety of languages, thereby enabling for example a universal remote of the present invention to include control functions in one or more user selected languages that may not otherwise be supported by one or more of the devices or their controller devices.

### Cloud Computing Generally

“Cloud computing” includes Internet based computing where shared resources, software and data are provided on demand. A “cloud” therefore can refer to a collection of resources (e.g., hardware, data and/or software) provided and maintained by an off-site party (e.g. third party), wherein the collection of resources can be accessed by an identified user over a network. The resources can include data storage services, word processing services, and many other general purpose computation (e.g., execution of arbitrary code) and information technological services that are conventionally associated with personal computers or local servers.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

In general, the concepts of “virtual” and “cloud computing” include the utilization of a set of shared computing resources (e.g. servers) which are typically consolidated in one or more data center locations. For example, cloud computing systems may be implemented as a web service that enables a user to launch and manage computing resources (e.g., virtual server instances) in third party data centers. In a cloud environment, computer resources may be available in different sizes and configurations so that different resource types can be specified to meet specific needs of different users. For example, one user may desire to use small instance as a web server and another larger instance as a database server, or an even larger instance for processor intensive applications. Cloud computing offers this type of outsourced flexibility without having to manage the purchase and operation of additional hardware resources within an organization.

A cloud-based computing resource is thought to execute or reside somewhere on the “cloud”, which may be an internal corporate network or the public Internet. From the perspective of an application developer or information technology administrator, cloud computing enables the development and deployment of applications that exhibit scalability (e.g., increase or decrease resource utilization as needed), performance (e.g., execute efficiently and fast), and reliability (e.g., never, or at least rarely, fail), all without any regard for the nature or location of the underlying infrastructure.

A number of factors have given rise to an increase in the utilization of cloud computing resources. For example, advances in networking technologies have significantly improved resource connectivity while decreasing connectivity costs. Advances in virtualization technologies have increased the efficiency of computing hardware by improving scalability and making it possible to more cloely match computing hardware resources to the requirements of a particular computing task. Additionally, virtualization technologies commonly deployed in cloud computing environments have improved application reliability by enabling failover policies and procedures that reduce disruption due to an application or hardware failure.

### System

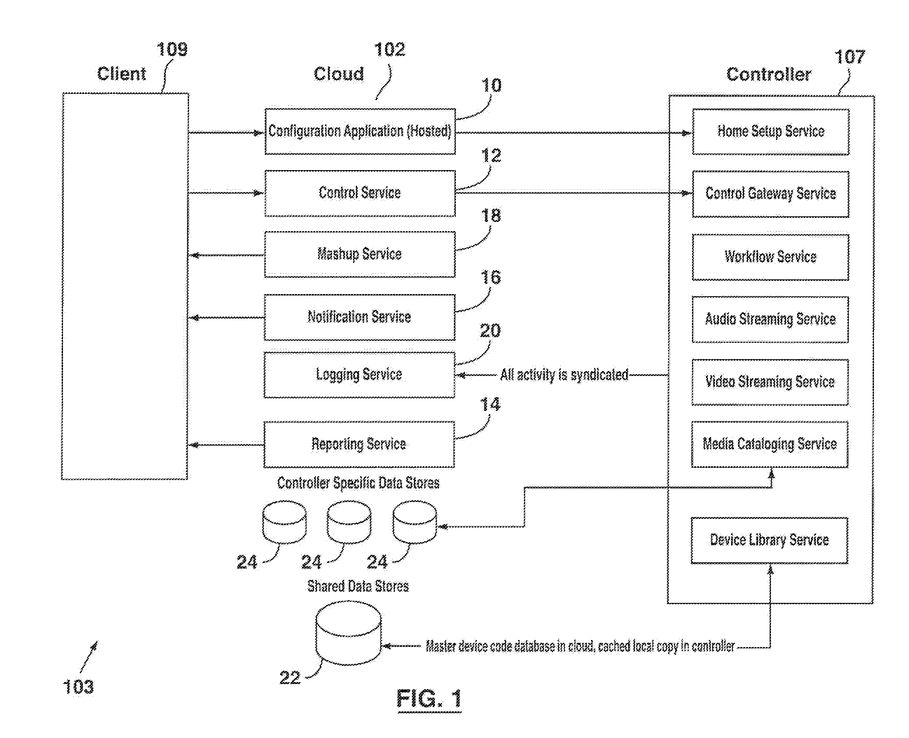

FIG. 1 shows a cloud-based network system in accordance with the present invention. The system, in one aspect thereof, includes: (1) a controller or main controller component, which provides the central control in connection with a plurality of control devices; (2) one or more control devices that enable communication with a variety of client devices, which are operable to initiate commands based on communication to the controller and (3) a cloud. Example client devices include smartphones running a proprietary application, in-wall touch screens custom developed for communication with the controller, a desktop computer accessing the system via a standard web browser, mobile tablets, televisions, laptops and desktops, etc. All client devices are operable to communicate with the controller via standard web protocols (http, https) by means of the cloud. Communication between the client device and the cloud/controller may be enabled using for example WebSockets.

In one aspect of the invention, the present invention provides a novel and innovative cloud based architecture that enables configuration of cloud based resources on an on demand basis based on a request from one or more client devices associated with the cloud management system 103 for specific functionality or resources. The cloud management system 103 is operable to receive the request(s) and based on the functionality resources, determine a set of cloud resources required to provide the functionality or resources, further based on device and network properties associated with the relevant client device 109. The cloud management system 103 is operable to dynamically configure the cloud resources linked to the cloud management system 103 in order to deliver the functionality or resources to the relevant client device 109. One or more specific mechanisms for enabling this functionality is further described below.

As illustrated in FIG. 1, the cloud management system 103 may act as an interface, whereby one or more users may set up resources on the cloud. For example, cloud management system 103 may facilitate web-based access to various administrative functions thereby enabling the user to configure the cloud-based resource using a conventional web browser application or a smart phone application, for example. This provides user driven configuration of cloud based resources via easy to use control interfaces familiar to users, which was not possible prior to the present invention. It is noted that based on prior art solutions, management of cloud based resources generally requires an cloud based management interface, usually implemented as an enterprise layer that may be cost prohibitive for consumer focused solutions, and also that generally requires that users learn to use one or more new interfaces to enable management of cloud based resourced. The present invention provides a particular method and a cloud based system and service architecture that enables users (including consumers) to access the advantages of cost effective cloud based services in a way that is easy to use, and that may include the user of existing devices, and interfaces similar to those with which they are already familiar.

For instance, the management system 103 may display to the user a list of resources or services that the user can utilize, along with a list of commands (e.g., start, stop, suspend, list) that can be executed to operate on, or with, certain resources. In particular, the cloud-based resources may comprise, for example, a list of preconfigured or customized machine images corresponding to virtual servers that can be instantiated in the cloud. The management system 103 may manage the available resources, including the physical servers and various associated services, delivered by the controller 107 leveraging cloud based resources as explained further below.

As best illustrated in FIG. 1, cloud management system 103 may use configuration data for setting up computing resources for different users, as further particularized below. The configuration data may for example specify the details of the computing resources to be allocated to a particular client 109. In one aspect of the implementation of the invention, the cloud management system 103 is operable to receive from the client 109 a customized machine image, thereby enabling the cloud management system 103 to obtain the configuration data for the client 109. A user of the client 109 may either initiate the capture of a customized machine image, or more likely select from a list of pre-configured machine images, which may be accessed using a menu implemented to the client 109 using for example an graphic user interface delivered to the client 109 as further explained below. The management system 103 may store configuration data in a repository 105, for example.

When the user desires to use one or more resources associated with the management system 103, the management system 103 is operable to generate the necessary commands for instantiating the virtual server on the appropriate physical server. For example, if a user desires a small amount of resources, the user may direct management system 103 to access configuration data specifying an image including a virtual CPU having a certain processing power and specifications, 1 GB of memory, and 100 GB of persistent storage. However, if the user desires a large amount of resources, the user may direct management system 103 to access configuration data specifying an image including multiple virtual CPUs having a certain processing power, 10 GB of memory, and 500 GB of persistent storage. The images are used to create server instances of the specified resources. Once the resources are instantiated, a link to the resources is sent to the user (e.g., an IP address) and the user may access the resources to run one or more services associated with the management system 103, which may be provided by cloud implemented software applications.

A controller may be located in a building that is to be monitored and/or controlled. The controller 107 is shown for example in FIG. 1. The controller 107 may implement a range of range of tools that enable the controller 107 to leverage cloud resources, and make these resources available via a range of different client device 109, without the need of significant integration of the clients 109 to a cloud service, for example by making a cloud management application accessible to the client devices 109. It should be understood that one aspect of the present invention is that there may be a number of different client devices 109, and also at a particular location certain client devices 109 may be replaced by new client devices 109. In other words, the location addressed by the solution of the present invention may provide a variable networking/computing environment. The present invention provides an innovative solution for addressing such an environment to enable the leveraging of the a variety of cloud based services.

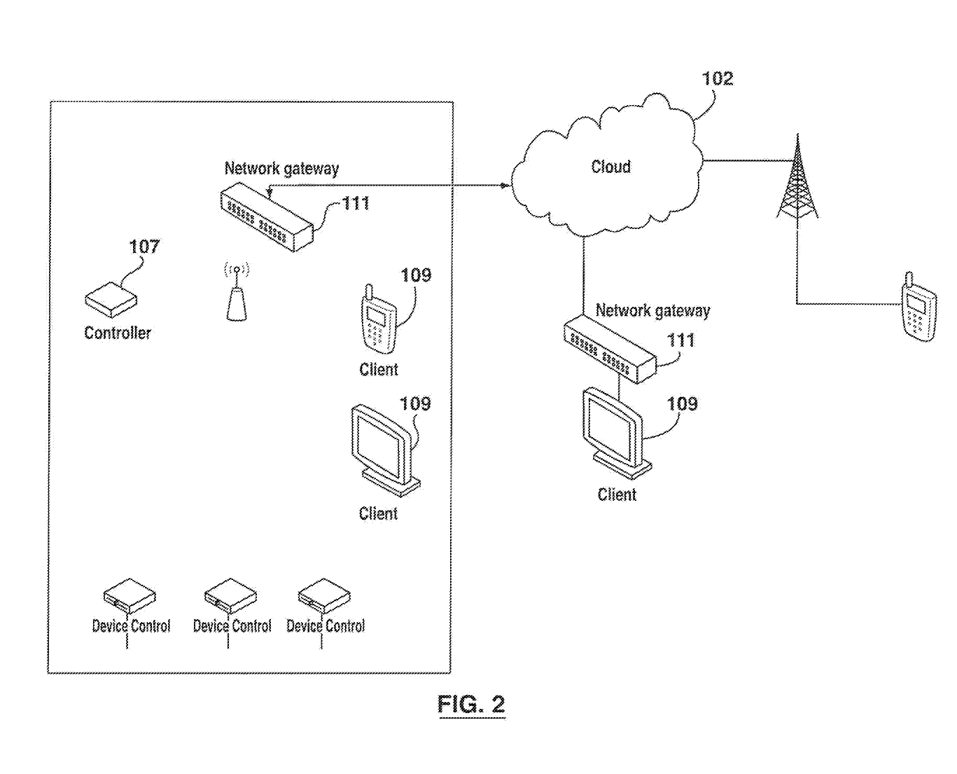

FIG. 2 illustrates a representative, high level network architecture showing a possible network environment for implementation of the present invention. A particular location may include a controller 107 which may connect to the cloud via the Internet, using for example a gateway 111. The controller 107 may connect to a variety of different client devices 109. The controller 107 may also enable control of a variety of other devices, leveraging in part cloud based resources made available using the management system 103.

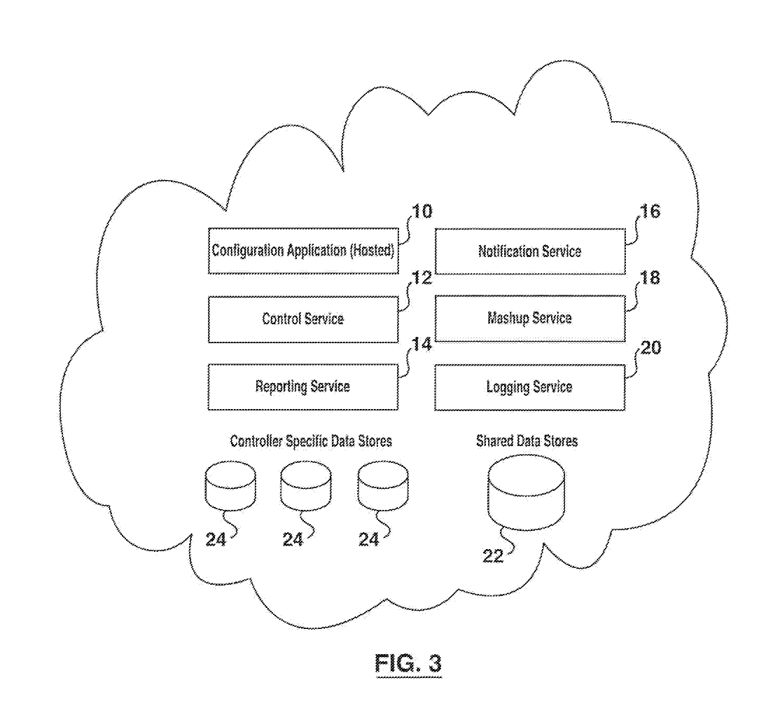

FIG. 3 illustrates the cloud based resources that are made available by the cloud based computing system and architecture of the present invention, namely a configuration application 10, a control service 12, a reporting service 14, a notification service 16, a mashup service 18 and a logging service 20. These services may be implemented using a variety of different cloud computing tools or services. These services provide one example of the implementation of the cloud based architecture and method of the present invention for enabling delivery of a range of cloud based functionality to one or more client devices 109.

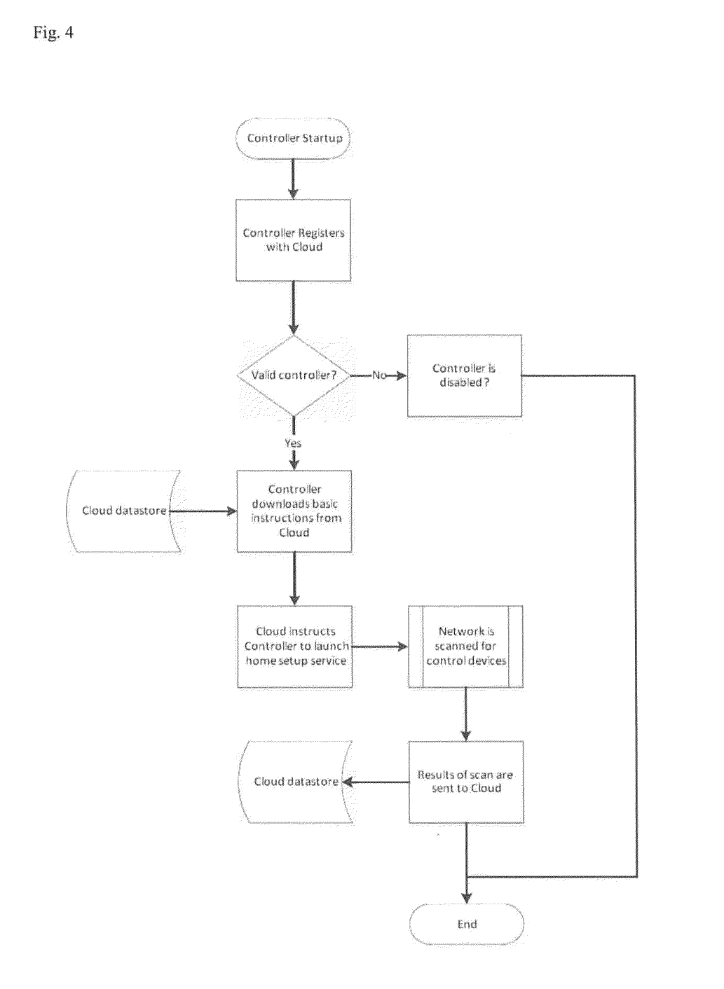

FIG. 4 illustrates a representative installation or setup of the present invention. A controller of the present invention is started up. It should be understood that there may one or more controllers associated with a particular location. Upon start-up, a controller communicates with the cloud and more particularly with the cloud based management system of the present invention and registers itself with a unique controller ID, for example. The controller accesses the cloud for example through the Internet via a unique URL that is managed in the cloud. The controller downloads, from the cloud, configuration instructions and control device codes, which are commands that can be understood by a plurality of control devices.

The particular configuration instructions and control device codes may be based for example on a profile built for the location or user(s) associated with the location. The profile may be built for example on the user types and thereby likely client devices that may be associated with the user based on the user type.

For example, an AN control device that understands IR (infrared controls) would require IR codes to transmit to a television or other AN device. Control device codes for various control devices can be obtained from many sources. As an example, IR codes may be sourced from an organization that provides licensed databases for IR codes. Other codes may be sourced directly from the manufacturer of the control device.

Alternatively, the controller is operable to initiate a discovery routine such as a LAN search to find possible control devices, and also collect information regarding such control devices. This information is sent by the controller to the cloud, and based on this information the management system is operable to retrieve and deliver to the controller the current and relevant codes for example.

As previously mentioned, a user may access the cloud management system 103 by means of an interface. One or more controllers associated with the location may download instructions and a set of control device interfaces from the server associated with the operator of the system of the invention, by means of the cloud, and using the management system 103. The available control device interfaces can change over time and controllers can download newly added control device interfaces from the cloud. These control device interfaces may operate like plug-ins that provides each controller with information on how to communicate with a control device. These control device interfaces may include information on how to locate control devices within a home network, for example, and information on how to communicate with the control device.

It should be understood that the controller 107 and the cloud based management system 13 are configured to provide a managed cloud service, delivered to one or more client devices 109. This managed cloud service may be used to access a range of different resources, a few examples of which are illustrated in FIG. 1. Significantly, using the method and architecture described, access to the services is provided to the client devices 109, whether the cloud is available or not, as further explained below.

Next, a user connects to a configuration application 10 via the managed cloud. The configuration application allows the user to define the control devices (e.g. location) and create activities, resources, schedules and automated tasks, which are further described below. Once configuration is complete, a subset of configuration data is transferred to the controller to provide offline operations, including based on the activities, resources, scheduled and tasks that the user wishes to access. By allowing for the storage of a key subset of configuration data, a controller can remain operational when the cloud network is not available. This can be extended to allow for controllers to be utilized in remote locations where an Internet connection is not available full time (e.g. a remote cabin).

Control devices do not need to be on the same network as the controller, but need to be accessible by the controller through some network. When connected to the cloud, the controller is able to provide much richer data to the clients. When operating without the cloud, the controller provides basic operations that allow the user to utilize the control devices within the premise but changes/additions/configuration of the devices may not be done without the cloud. In addition, adding of media to a user's collection cannot be done without the cloud. The cloud also provides access to additional services, such as Internet radio stations, or movie streaming, which would not be available if the controller cannot access the cloud.

During the configuration process (or anytime later) client devices may be registered and paired with the controller. Once configured, a client device can issue control commands to a paired controller. Commands can be issued whether the client device is located on the same LAN as the controller or not. In the case where the client device is not located on the same LAN as the controller, commands are issued thru the managed cloud. Example of commands include, “turn on veranda lights”, or “channel up on great room TV”.

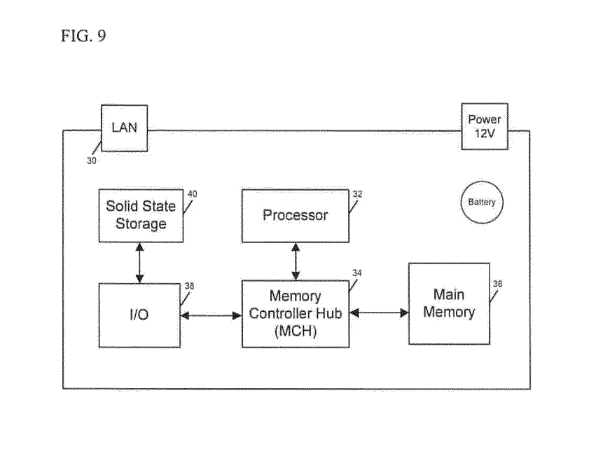

The controller may be a combination hardware and software elements, for example embodied as a customized hardware device that executes controller software. FIG. 9 illustrates an example of implementation of the controller 107. The controller may include resources for communicating with a LAN 30, if one is available. The controller generally includes a processor 30, a memory controller hub 32, main memory 36, an I/O 38, and a solid state storage unit 40.

The controller communicates with control devices, and to the cloud via a network (e.g. LAN). By using a wireless bridge connector linked to a LAN connector of the controller, the controller can operate in a wireless network. A controller, as illustrated for example in FIG. 9, may include a “boot loader” stored on solid state storage, or any other persistent storage linked to the controller. The boot loader initiates the connection to the cloud and downloads the controller software (e.g. the services described below) when the controller is started/powered on. This ensures that controllers can be provided with the latest controller software and may optionally allow for the ability to self-destruct a controller if it is not an authorized device. It should be noted that many typical consumer electronic devices comprise processors, internal storage, network connections and support software frameworks allowing for third party software development (e.g. apps), such that these consumer electronics could be utilized as controllers.

The controller software may include or be linked to a control gateway component or service, a media catalog component or service, a workflow component or service, an audio streaming component or service, a video streaming component or service, a home setup component or service and a device library component or service.

The control gateway service may provide an interface for sending commands from the controller to various control devices, for example commands associated with infrared (IR), Recommended Standard (RS), Universal Powerline Bus (UPB) or any other applicable protocol. The control gateway service routes a message/instruction between the controller and the appropriate control device. For example, sending the control gateway service a “turn family room lights on” command may route the command to the approprite lighting interface. This service is also utilized for other functions such as initializing or customizing a control device, providing the status of control devices linked to the controller, locating other services on the network (e.g. via UDP beacons), and configuring the control device interfaces (global cache units, etc.) and the devices that are accessed via those interfaces.

The media catalog service enables the cataloguing of users' media on users'. The media may be stored on Network Attached Storage (NAS), for example. The media catalog service may be provided in the cloud but initiated by the controller. The media catalog service aggregates the media within a network/home and creates a catalog of media locations.

There need be no direct interaction between the user and the media catalog service. The user may simply define locations to scan/watch through the configuration application 10, which in turn invokes the media catalog service to perform the actual scanning. On initial launch of the controller, the media catalog service may initiate a scan of the local network using the controller as the gateway. The local network is scanned for media files based on file type matching (e.g. a .mp3 file is a music file). Scanning of the network is done using a network discovery protocol which looks for services (in this case, file system service and DLNA) and returns a list of files.

Once the network is scanned by the controller the cloud is notified of the results (a list of files and locations discovered). This information is stored in a media database within the cloud. A “watcher” is a service that runs within the controller to monitor local network locations for changes to those locations. The media catalog service can be configured to “watch” those locations for changes (ie. additions, deletions). Other locations to “watch” can be added manually through the web configuration application. Locations do not need to be on the local network, but can reside anywhere as long as they are network accessible.

Once the initial scan is complete, the media catalog service may then extract meta-data and populate additional information in the media database. For example, for music files that have embedded meta-data (e.g. artist, album, etc) the information may be extracted and stored in the database, and a lookup can be performed on the Internet-based All Media Guide service to gather additional information on the music (e.g. album review, artist bio, etc). This extended meta-data is also stored in the media database. For other media types such as video, or pictures, meta-data can also be extracted and stored in the media database

The media catalog service locates files/documents that match a particular format. In this way, the media catalog service could be used to catalog Word documents, or any other file formats. The unique features of the media catalog service include that a user can define locations to catalog. Thus, the user could have the media catalog service scan through a remote network and/or across the Internet. This allows the user to be able to maintain a media collection anywhere that is network (or Internet) accessible.

The workflow service enables the issuing of messages to the control gateway service in accordance with one or more workflows that may be user configured or configured by means of analysis of control device usage. For example, a user may configure a workflow to give the user's house a “lived in” look while the user is on vacation. Other workflows could require user interaction (e.g. when any person leaves the user's house without arming the alarm, a notification could be sent to the user who could reply back with the appropriate instruction to arm the alarm; if the user is unreachable after 5 minutes a notification gets sent to a second user, etc.).

The audio streaming service is responsible for managing the music catalog and providing access to the music files. In addition, it includes services for streaming music to a remote device. There are three main functions provided by the audio streaming service: 1) search, 2) browse and 3) stream.

When a search is preformed using search parameters, the audio streaming service searches the database for results matching the search parameters. The search can be performed on any or all available meta-data for music files (e.g. artist name, album name, song name, genre, tone, style, etc). In addition, a search can be based on location (e.g. display music files located on a PC, or located on NAS). The search function not only searches across the music files in the music catalog, but may include the ability to utilize the cloud to perform a search against external sources of music (e.g. Pandora, Napster, iTunes) through APIs. As an example, a search for “Michael Buble” could return back results of music files located in the catalog (found during the media scanning) as well as results from scans of external data stores.

A browse function of the audio streaming service enables a user to systematically explore the music catalog, refining the results through a top-down approach. Browsing can further be filtered, sorted and explored by meta-data category (e.g. by artists, by album, by tone, by type, by location). External sources can also be browsed through the cloud. The search function can lead into a browse function.

The audio streaming service may provide for locating a media file and transferring the media file to a DAC (Digital to Analog Converter) for playback purposes. A client may provide the audio streaming service with the location of the media file and the media file can stream from that location to the DAC. The audio streaming service handles transport controls: shuffle, next, previous, etc. The audio streaming service therefore enables streaming of audio from its location to a remote device, such as a smartphone, for example, by means of the managed cloud services.

The video streaming service interfaces with a user on a customized home theatre computer. The video streaming service may obtain video from a Uniform Resource Identifier (URI) and play the video to the user. The video could be stored in the cloud, or on NAS. The user provides the streaming service a URI, by means of the media catalog, which enables the video streaming service to locate an available playback device and instructs the playback device on what to stream. Playback devices may be located through the use of agents that reside on the playback devices. Agents are essentially listeners that listen for broadcast commands on a particular port on the home theatre computer.

The home setup service gathers the data related to the premise (home/building) and creating activities/events/triggers based on that data. The home setup service creates and stores the configuration of all control devices within the premise and how they interact with themselves and external activities/events/triggers.

The home setup service is initially launched when the controller first connects to the cloud. At that point, the home setup service launches a scan of the local network for control devices. Once the scan is complete, the controller sends the results (a list of control devices and their IDs, or other means of linking to the control devices) to the controller. At that point the home setup service is concluded until it is invoked by a user through the configuration application.

A user may connect to the configuration application to continue the home setup. The home, setup service provides information for all of the control devices that were found within the premise. The user can use the home setup service to add additional control devices that were not found during the scan, or were added after the initial scan.

The user utilizes the configuration application and the home setup service to define the number of rooms in the premise, and the names of those rooms. In addition, each control device is assigned to a room (e.g. lighting control device 1 is located in Den). This information is stored in a central database within the cloud. The user can configure each control device using the home setup service. These specifics can include the type of equipment the control device is connected to and the general operations of that control device. Once rooms are defined, control devices may be assigned to rooms and activities can be created. Activities may be a set of commands to perform (e.g turn on lights). Activities can be scheduled, triggered or manual. In subsequent use, client devices query the home setup service to obtain the layout of the premise (e.g. gather a list of rooms, display what control devices are in each room).

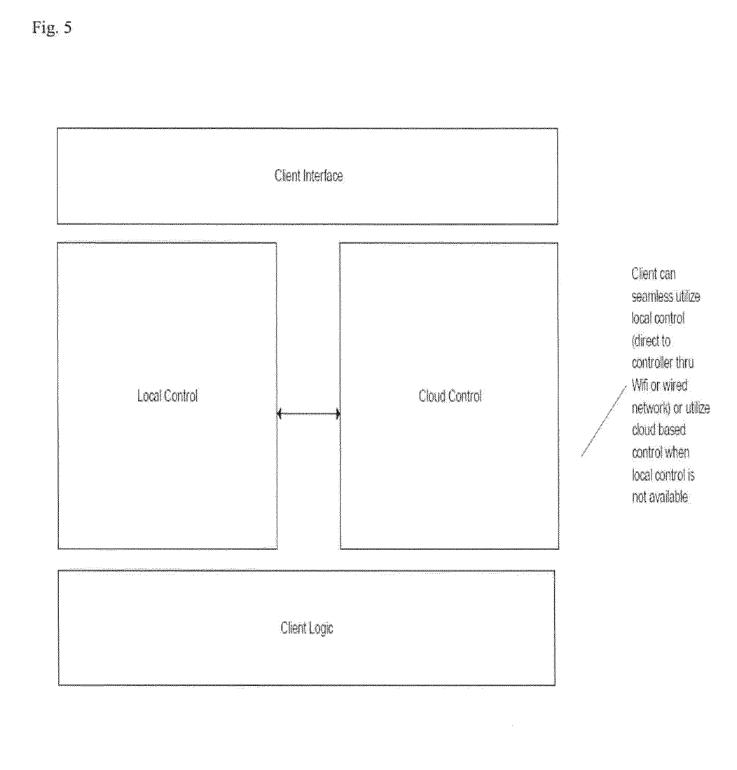

The device library service manages a catalog of control device codes/commands. The actual catalog may be stored in the cloud, however the controller may provide a local cache for the control devices it needs. The device library service is primarily used during the configuration process of the controller or when devices are being added/replaced. As illustrated in FIG. 5, a client device may utilize local control (directly with the controller by means of a local wired or wireless network) when the local cache is available by means of the controller, or directly to the cloud where the controller is not available.

On start-up, a controller may register itself with the cloud. During this registration, the controller downloads a default configuration which includes a list of support devices. The controller then scans the local network for these devices. The user configures the devices through the configuration application. The device library service provides access to the stored list of devices, and their various functions. Each device can have a unique method of communicating and that information is managed by the device library. In addition, parameters for devices can also be determined. For example, if the user has a television, the device library would provide the IR codes to be able to control the TV. For a set of motorized shades, the device library would provide the RS232 codes for controlling the motorized shades.

Further services may be provided on the cloud, including the configuration application, logging service, control services, notification services and reporting service. FIG. 3 illustrates cloud-based services.

The configuration application is a web based software application hosted in the cloud. It is utilized by home owners and custom installers to configure a controller. Users connect to the configuration application and register their controller usirig the controller's unique ID. The configuration application is used to configure the various components of the controller and setup the meta-data (e.g. room names, device names, etc). The configuration application uses a central store for pulling meta-data required during configuration (e.g. IR codes, device types).

The central store is utilized across all controllers/users for configuration. Controller/user specific configuration is stored in controller/user data stores. In addition to configuring the meta-data for the controllers, users can subscribe client devices to event notification.

The configuration application provides a wizard approach to allow home owners to first define control devices. An example of this is defining a control device in a house for controlling a TV. The user would choose the correct control device, provide its location (e.g. Family Room) and create activities or automation rules for the device (i.e. a workflow). An activity might be something like “watch Satellite”, and within this activity the family room TV would be turned on and set to the correct input. Automation rules can also be created for any control device (e.g.

when the alarm is armed for away, the TV is turned off). The automation rules are stored in the cloud. A subset of the activities is sent to the controller for local offline use. Schedules and automated tasks are only executed when connected to the cloud. Activities are stored in the local controller, in one particular implementation, in a JSON format allowing for fast retrieval and requiring less processing to execute. Activities, schedules and tasks are stored in the cloud in a database, allowing a user to easily search for them and create multiple activities that can be reused.

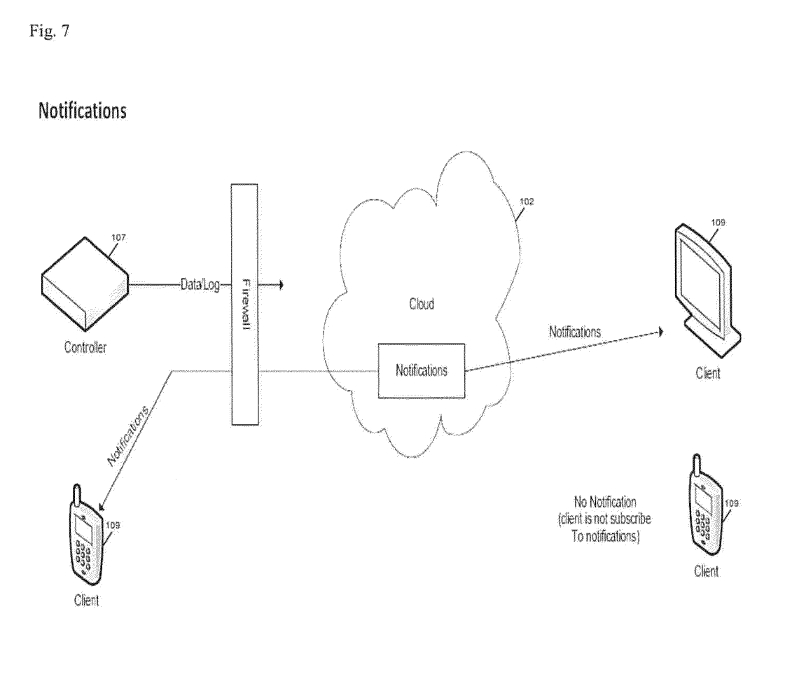

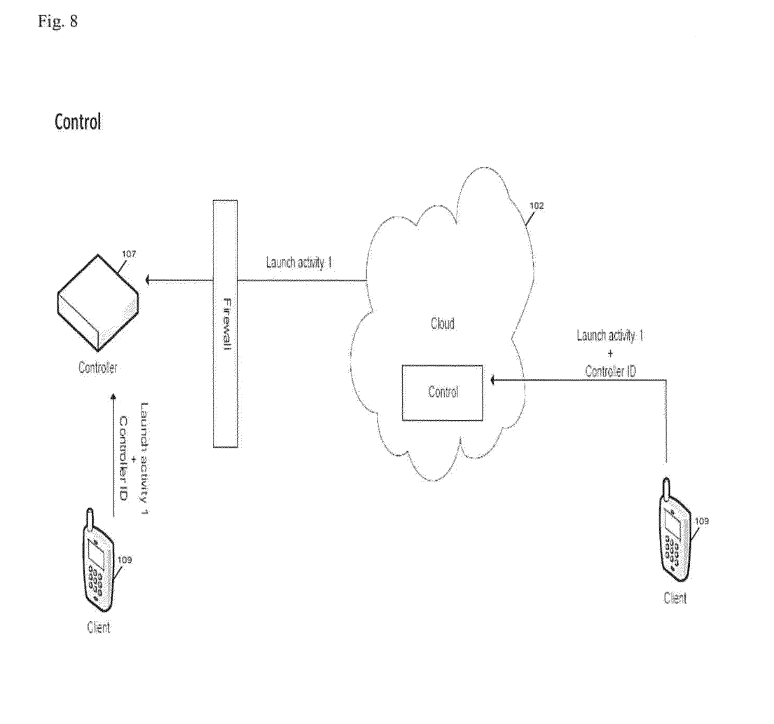

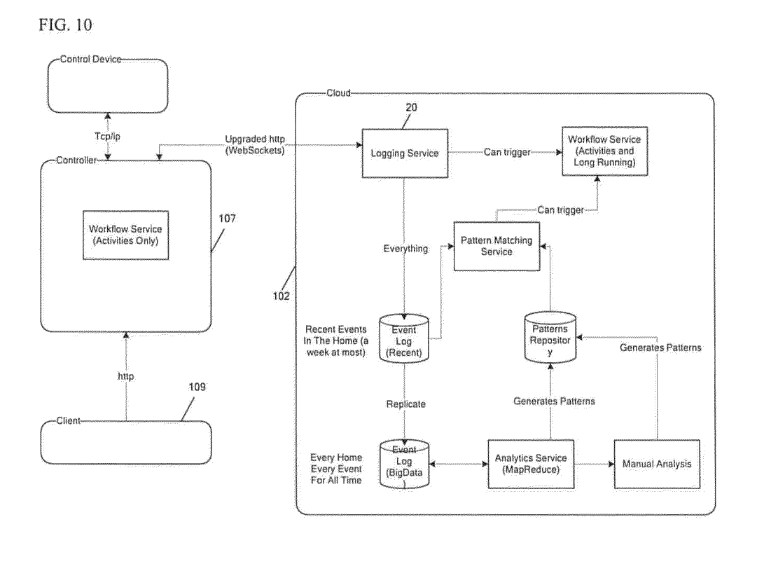

FIG. 10 illustrates operation of the present invention based on monitoring of a control device. The logging service 20 logs activities/events that are broadcast from the controllers to the cloud (e.g. a log of events). Each of the controllers will syndicate their data to the cloud. The logging service 20 gathers all of the data fed to it from all controllers and parses the data. The data is parsed and key events execute triggers. Triggers can be notification events, in which the logging service sends the pertinent data to the notification service, or a command execution can be triggered, whereby the logging service instructs the control service to execute a command (e.g. motion sensory was triggered, so turn on the lights in room x). Event logs may include an event log (Recent) and event log (BigData). Notifications are shown, for example, in FIG. 7. Control is shown, for example, in FIG. 8.

An additional feature of parsing the data is recognition of patterns. Once patterns are recognized, activities can be generated. Home owners would be notified of these dynamically generated activities and they would be automatically added to the home owner's controller's configuration and to the client devices.

Patterns may be matched by a pattern matching service. The pattern matching service may be linked to a pattern repository that is a collection of algorithms that can grow over time based upon the continuous analysis of the Event Log (BigData) by the analytics service. The pattern matching service uses the algorithms available in the pattern repository to evaluate data in the Event Log (Recent) to determine if a workflow should be triggered (or resumed), for example.

The analytics service provides a mechanism for analysing large amounts of data and looking for usage patterns that can be used to tune algorithms in the pattern repository. The analytics service provides the capability to aggregate a subset of data so that it can be used for manual and statistical analysis. This would allow the creation of new algorithms based on this analysis.

Control services allow for remote control of the controller within a home. Commands can be issued to the control service in the cloud and those commands are delegated to the correct controller. Each command sent to the control service may be encrypted with the controller ID and the client device ID. The control service ensures the controller and the client device are paired and that the client device is authorized to transmit commands to the controller. The control service utilizes the controller ID to determine which controller to issue the command to.

The notification services notify clients of events. Through the configuration application users can choose which events a-client device gets notified of (e.g. notify my phone of an alarm, but don't notify the kids' phones). The client devices process the notification and determine how best to handle the notification.

The reporting service provides three levels/categories of reports: (1) home owner reports; (2) management reports; and (3) data mining. Home owner reports are constrained to the home owner's controller's data. Examples of reports are: energy usage, current status, alarm activity, TV watching activity. Management reports would cross multiple controllers' data stores. Data mining would offer additional data such as music listening patterns, TV watching patterns and usage patterns.

The workflow and analytics functionality of the present invention is based on the continuous communication of events from the controller (e.g. lights on, tv on, play song, etc) to the cloud-based logging service. The controller and cloud maintain a duplex communication path to allow communication in either direction. Once the events have been communicated to the logging service, they may be interpreted and can result in a number of different actions, including: (1) event logged to the event log (Recent) and replicated to the event log (BigData); (2) events trigger a workflow or resume a bookmarked workflow; (3) once logged to the Event Log (Recent), events may be analysed by the pattern matching service and may trigger a workflow or resume a bookmarked workflow.

### Computing Environment

The description above discloses at a high level the various functions of the proposed control/management solution for a plurality of devices at the location.

In order to provide additional context for various aspects of the subject innovation, the following discussion are intended to provide a brief, general description of a suitable computing environment in which the various aspects of the present invention can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer (such as the computer(s) illustrated in the architecture described above) typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer. Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system of the present invention represents a collection of hardware and software elements that enable a user to manage a variety of device and information objects associated or generated by these devices, leveraging in-the-cloud resources in a new way.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

It should be understood that the present invention may be extended by linking the invention with other technologies or processes useful in the monitoring, control or management of a variety of devices, for a variety of purposes.

1. A system for providing monitoring, control, and/or management network infrastructure comprising:
(a) a cloud based computing environment, including a cloud based management system for enabling the management of access to one or more cloud based services that are part of the cloud based computing environment; and
(b) at least one controller, installed to a location, that is configured to (i) discover one or more properties associated with one or more client devices at the location, (ii) interface with the external cloud based computing environment, and link to the cloud to obtain programming for enabling configuration information for (A) enabling the one or more client devices to connect to the controller to obtain one or more services from the managed cloud services, and (Bi) enabling the one or more client devices to obtain a subset of the one or more services from the controller when the managed cloud services is not available.

2. The system of claim 1 wherein the system interoperation with the cloud for monitoring, controlling, or managing the one or more devices.

3. The system of claim 1 wherein the controller interoperates with the cloud to: (i) offload data manipulation and management to the cloud; (ii) provide remote access to or control of the main controller component; and/or (iii) utilize the cloud as an automated service for access to remote storage and processing in association to enhance the operation of a plurality of devices at the location.

4. A computer-implemented method for enabling the monitoring, control and/or management of one or more devices:
installing at least one controller at a Vocation associated with the one or more client devices;
the controller connecting to the a cloud based computing environment that includes a cloud based management system, the controller being operable to cooperate with the cloud based computing environment to provide access to a managed cloud service; and
the cloud based management system providing to the controller via an Internet connection programming for (i) enabling the one or more client devices to connect to the controller to obtain one or more services from the managed cloud services, and (ii) enabling the one or more client devices to obtain a subset of the one or more services from the controller when the managed cloud services is not available.

5. The method of claim 4, wherein the controller obtains information regarding the one or more devices and based on this information the controller obtains configuration information for the controller to connect to the one or more devices, and to enable the controller to monitor, control and/or manage the one or more devices.
